(19) United States
(12) Patent Application Publication
(10) Pub. No.: US 2005/0141795 A1
(43) Pub. Date: Jun. 30, 2005

(54) Bearing containing wireless information transmission unit

(75) Inventor: Alain Bochet, Seynod (FR)

Correspondence Address: MICHAEL BEST & FRIEDRICH, LLP, 100 E WISCONSIN AVENUE, MILWAUKEE, WI, 53202, US

(73) Assignee: Timken US Corporation

(21) Appl. No.: 10/959,636

(22) Filed: Oct. 6, 2004

Related U.S. Application Data
(63) Continuation of application No. 10/223,419, filed on Aug. 19, 2002, now abandoned.

(30) Foreign Application Priority Data
Dec. 19, 2001 (FR) 0116486

(51) Int. Cl. G01B 1/00; F16C 41/04; F16C 32/00

(52) U.S. Cl. 384/448

(57) ABSTRACT

The invention relates to a bearing or bearing assembly of the type containing, between a stationary ring and a rotating ring, a unit that includes an encoder-support armature; a device for measuring the pulses emitted by the encoder; and a sensor-support armature; and in which the unit also includes a radio transmitter connected to said measuring device in such a way as to transmit a radio wave representing the signals generated by said device to an external receiver designed to be located away from the unit, said receiver being capable, on the basis of these waves, of addressing to a computer the signals necessary for calculating the direction of rotation and/or speed of rotation and/or position of the encoder in relation to the measuring device.

### FIELD OF THE INVENTION

The present invention relates to a bearing or bearing assembly designed to be mounted between a stationary support and a rotating support, and a process for installing such a bearing.

The invention relates more particularly to measuring the direction of rotation and or/speed of rotation and/or position of the rotating support in relation to the stationary support. In addition, the invention is can provide means for sealing the bearing or bearing assembly from its environment.

The invention applies in particular to the field of vehicle wheel bearings, said bearings having a rotating ring and a stationary ring between which a built-in multi-pole magnetic encoder unit is installed, it being possible to pre-assemble said unit.

### BACKGROUND PRIOR ART

There are known assemblies constituting a seal with a built-in multi-pole magnetic encoder that include:
an encoder-support armature to which the encoder is attached;
a device for measuring the pulses emitted by the encoder that is able to generate digital signals as a function of the magnetic field being measured; and
a sensor-support armature to which the measuring device is attached at air gap distance from the encoder.

In known assemblies of prior art, electric cables are used to connect the measuring device to a computer capable of processing and delivering the desired information to a vehicle wheel anti-lock or anti-skid system, for example.

The electric cables have a dual function: first, to supply the measuring device with power and, second, to transmit the measurement signals from the measuring device to the computer.

This type of technology presents a number of disadvantages.

In particular, this type of assembly requires that the measuring device be positioned very precisely in relation to the encoder in order to maintain the required air gap distance, creating great inconvenience during installation due to the presence of the electric cables.

In addition, the electric cables are exposed to very harsh bearing environments, particularly in vehicle wheel applications.

Moreover, the prior art assembly designs must vary according to whether the inner ring or outer ring of the bearing is rotated, because the presence of electric cables makes it difficult to rotate the measuring device.

To address and eliminate these disadvantages, document U.S. Pat. No. 5,898,388 describes an assembly that uses an inductive device to transport both electrical power and the measurement signal between two telemetry units, one of which is positioned in the assembly, the other of which is located away from the assembly.

One disadvantage of this assembly is that the second telemetry unit must be positioned in the immediate vicinity of the first one, because the information is transmitted by means of a magnetic field whose intensity diminishes exponentially as a function of distance.

Such an assembly is thus difficult to install, because the second telemetry unit must be precisely positioned with regard to the first and respect the required air gap, that is, be placed within a distance of a few millimeters of the first device, with an acceptable tolerance on the order of 10%.

### SUMMARY OF THE INVENTION

The object of the present invention is thus to address and eliminate all of these disadvantages by providing, in particular, a bearing equipped with a built-in multi-pole encoder unit that may be pre-assembled and constitute a seal, in which:
the measuring device is incorporated during manufacture, and
the measurement signals are transmitted between the measuring device and the computer by means of a radio transmitter/receiver whose transmitter is attached to the unit and whose receiver is external to it.

Because the measuring device has no electric cables, it may be rotated easily. For this reason, using the same assembly design, the measuring device may be attached to either the rotating ring or the stationary ring, making assembly design independent of the choice of rotating bearing part.

In addition, with this assembly the restrictions on the placement of the receiver in relation to the transmitter are removed.

Indeed, the intensity of a radio wave, whose magnetic field component is coupled to the electric field component, diminishes by 1/X, X being the transmission distance between the transmitter and the receiver. Thus the receiver may be positioned anywhere in the vehicle, at a distance of up to several meters from the transmitter.

Moreover, during bearing installation, if the unit is pre-assembled, restrictions relating to the position of the measuring device in relation to the encoder may be entirely removed.

To this end, and according to one embodiment, the invention provides a bearing or bearing assembly of the type that contains at least one stationary ring designed to be attached to a stationary structure, at least one rotating ring designed to be attached to a rotating structure, rolling elements between said rings and, installed between a stationary ring and a rotating ring, a unit that includes:
an encoder-support armature to which the encoder is attached;
a device for measuring the pulses emitted by the encoder that is able to generate digital signals as a function of the magnetic field being measured; and
a sensor-support armature to which the measuring device is attached at air gap distance from the encoder;
and in which the unit also includes a radio transmitter connected to said measuring device in such as way as to transmit a radio wave representing the signals generated by said measuring device to an external receiver designed to be located away from said unit, said receiver being capable on the basis of these waves of addressing to a computer the signals necessary for calculating the direction of rotation and/or speed of rotation and/or position of the encoder in relation to said measuring device.

According to a second embodiment, the invention provides a process for assembling such a bearing that includes the following steps:
pre-assembly of the unit,
installation of the pre-assembled unit between a stationary ring and a rotating ring of the previously installed bearing.

### BRIEF DESCRIPTION OF THE DRAWINGS

Other objects and advantages of the invention will become apparent during the description that follows, made with reference to the attached drawings in which:

FIG. 1 provides a partial view and radial section of a bearing equipped with a unit constituting a seal with a built-in multi-pole encoder, according to one embodiment of the invention.

FIG. 2 provides a partial view and radial section of a bearing equipped with a unit constituting a seal with a built-in multi-pole encoder, according to another embodiment of the invention.

FIG. 3 provides a simplified electronic diagram of the measuring device and the radio transmitter/receiver system of the assembly represented in FIGS. 1 and 2.

### DETAILED DESCRIPTION

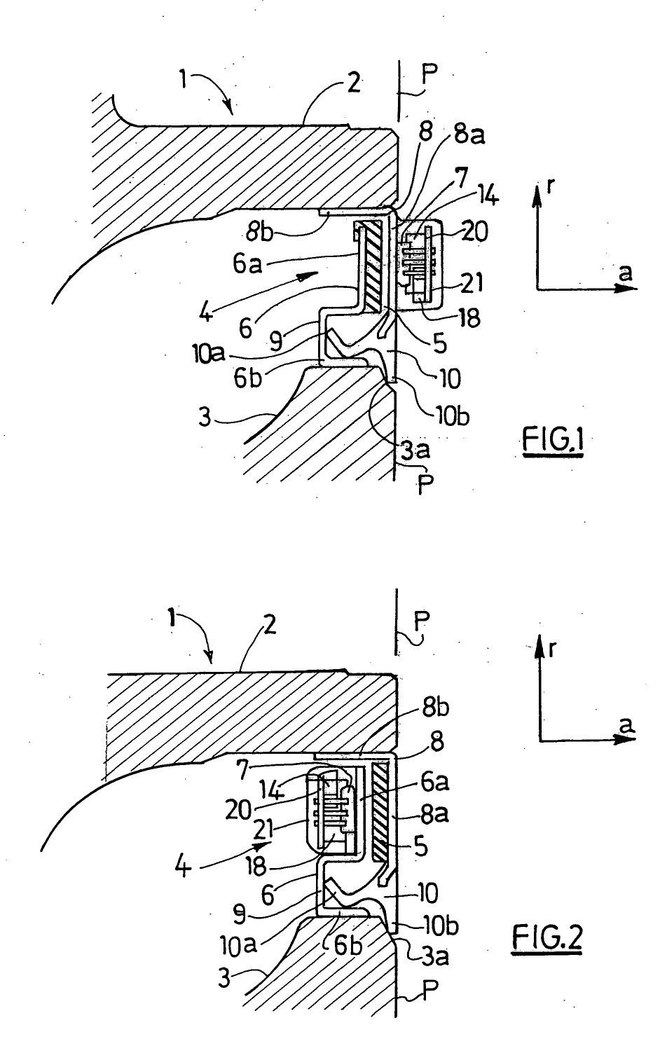

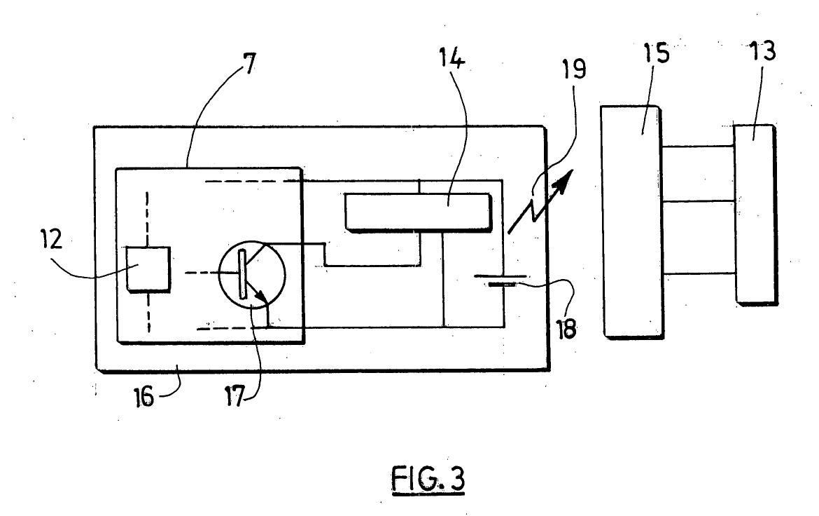

FIGS. 1 and 2 show a sealed bearing 1 of the type that includes a stationary ring 2 designed to be attached to a stationary structure, a rotating ring 3 designed to be attached to a rotating structure, and rolling elements (not shown) between the rings. In a variation not shown, the bearing may be equipped with more than one stationary ring 2 and/or rotating ring 3.

According to one particular example, this bearing 1 may be installed between the chassis of an automobile vehicle and the wheel hub of said vehicle in such a way as to allow said wheel to rotate.

Between the stationary ring 2 and the rotating ring 3 of the bearing 1, a unit 4 is coaxially positioned constituting a seal with a built-in magnetic encoder 5.

According to the embodiment shown, the inner ring 3 is the rotating ring and the outer ring 2 is stationary; however, as will be seen from the rest of the description, the design of the unit 4 would be the same if the outer ring 2 were the rotating ring.

A primary object of the unit 4 is to measure the direction of rotation and/or speed of rotation and/or position of the stationary ring 2 in relation to the rotating ring 3.

A further object of the unit 4 (as shown in FIGS. 1 and 2) is to provide a means for sealing the bearing 1 in such a way as to insulate the rolling elements and the bearing races from the environment surrounding the bearing 1.

To this end, the unit 4 includes:
an encoder-support armature 6, 8 to which the encoder 5 is attached;
a device 7 for measuring the pulses emitted by the encoder 5 that is able to generate digital signals as a function of the magnetic field being measured; and
a sensor-support armature 8, 6 to which the measuring device 7 is attached at air gap distance from the encoder.

The armatures 6, 8 are made of non-magnetic materials, for example metallic or polymeric materials.

In the embodiments illustrated in FIGS. 1 and 2, the armature 6 includes a radial disk 6a and an immovably attached axial cylindrical roller bearing 6b force-fitted onto the inner ring 3 of the bearing 1.

The armature 8 includes a radial disk 8a on the end of which an axial cylindrical roller bearing 8b is formed which is force-fitted onto the outer ring 2.

The armature 6 is placed inside the bearing 1 in relation to the armature 8 with enough play between them to allow each of them to rotate.

In the description, the terms “axial” and “radial” are defined in relation to the directions “a” and “r” shown on FIGS. 1 and 2.

The armature 6 also includes an axially shifted annular groove 9 formed between the disk 6a and the roller bearing 6b.

The seal consists of a shield 10 made of elastomer material, for example VITON, acrylonitrile, or similar materials, with an axial lip 10a and a radial lip 10b molded onto the radial disk 8a of the armature 8.

Lip 10a is positioned in the groove 9 resting against the free inner face of disks 6a and 6b, and lip 10b is resting directly against in a groove 3a in the inner ring 3.

In this embodiment, the relative positioning of the armatures 6, 8 and the use of the elastomer shield 10 make it possible to dynamically seal the bearing 1 during the rotation of armature 6 in relation to armature 8.

In the embodiments shown in FIGS. 1 and 2, the outer faces of the rings 2, 3 and the disk 8a are contained more or less within a plane P in such a way as to limit the axial dimensions of the bearing 1 and to facilitate mounting of the unit 4 onto the bearing 1.

In the embodiment shown in FIG. 1, armature 8 supports the measuring device 7, which is attached to the outer face of disk 8a, and armature 6 supports the encoder 5, which is molded onto the outer face of disk 6a.

In the embodiment shown in FIG. 2, armature 6 supports the measuring device 7, which is attached to the inner face of disk 6a, and armature 8 supports the encoder 5, which is molded onto the inner face of disk 6a. In this embodiment, the placement of the measuring device 7 inside the bearing makes it possible to avoid increasing the axial dimensions of said bearing.

We shall now describe the measurement function used to determine the direction of rotation and/or speed of rotation and/or position of the stationary ring 2 relative to the rotating ring 5, which is accomplished by means of the encoder 5 and the measuring device 7, which is located at air gap distance from the encoder 5. Alternatively, it is similarly possible to measure the relative direction of rotation and/or relative speed of rotation and/or relative position of ring 2 in relation to ring 5 [sic], that is, to rotate the stationary ring 2 in relation to the rotating ring 3.

For example, the encoder 5 is a ring-shaped part made of synthetic material embedded with ferrite particles constituting a series of contiguous domains, each of whose direction of magnetization is opposite to that of the two domains that are contiguous with it.

According to one variation, the measuring device 7 includes at least one sensing element 12 placed opposite the encoder 5 at air gap distance from the encoder.

According to another variation, the measuring device 7 includes a plurality of aligned sensing elements 12.

In both of these variations, the sensing elements 12 may be selected from among the Hall effect sensors, magneto resistors, and giant magneto resistive speed sensors.

The principle for sensing the signals emitted by the encoder 5 and processing them is explained, for example, in documents FR-A-2 769 087 and FR-A-2 769 088, written by the applicant, and will not be repeated here.

However, for clarity, is should be stated that the measuring device 7 delivers at least two electrical signals in sinusoidal form, of the same amplitude, centered on the same average value, and in quadrature in relation to one another.

Electronic processing techniques are used to convert these signals to digital form, and an electronic computer 13 uses these digital signals to calculate the direction of rotation and/or speed of rotation and/or position of the stationary ring 2 in relation to the rotating ring 3.

According to one variation, the measuring device 7 can include an interpolation device to increase the resolution of the output signals, as described in document FR-A-2 769 087.

The following description relates to FIG. 3 and concerns the measuring device 7 and a transmitter/receiver system capable of transmitting a radio wave representing the signals generated by said measuring device 7 from a transmitter 14 to an external receiver 15 located away from the unit 4.

The radio transmitter 14 is, for example, built in to the measuring device in an ASIC circuit (application-specific integrated circuit) 16, which is attached, for example by gluing or similar means, directly to disks 8a, 6a of the armature 8, 6, with the sensing elements 12 located opposite and at air gap distance from the encoder 5.

The circuit 16 incorporates the sensing elements 12, the electronic means for processing the sensed signals (not shown) and connected to them, by means, for example, of an output switching transistor 17, to the radio transmitter 14.

According to a preferred embodiment, all of these components are incorporated into the circuit 16 in a circular manner in such a way as to limit imbalance during rotation.

In the embodiment shown in FIG. 2, the circuit 16 also includes a battery 18 for supplying electrical power.

In order to conserve the energy of the battery 18 and thus prolong its service life, a device may be installed to place the transmitter 14 in standby mode when it is not sensing any relative movement between the encoder 5 and the measuring device 7.

According to one variation, the radio transmitter 14 can receive its electrical energy supply from a coil connected to the alternating magnetic field generated by the encoder 5.

For example, the coil can be installed on the integrated circuit 16 in the form of a spiraling circular track located at air gap distance from the encoder 5 in such a way as to generate the energy needed for the circuit 16.

Thus, the power needed for the measuring device 7 and the transmitter 14 is generated in the unit 4 itself, eliminating the need for connecting electric cables to an external power supply.

The measuring device 7 emits digitalized signals which, in the form of leading and trailing edges, activate the transmitter 14 with each change of state; the transmitter 14 then generates a high-frequency coded radio wave 19 of short duration identifying the measuring device 7 and type of transition (leading or trailing edge).

The signals are then transmitted from the transmitter 14, which is attached to the unit 4, to the external receiver 15 by means of an antenna 20 that is attached to the radio transmitter 14 in such a way as to eliminate, again, the need for connecting electric cables between the unit 4 and an external part.

The antenna 20 can be comprised, for example, of a circular copper track incorporated into the circuit 16 in such a way as to limit the dimensions of the measuring device 7, in particular if it is rotated with the rotating ring.

In addition, and still in the case of rotating the measuring device 7, a circular antenna 20 eliminates the need to assign the directivity of its radiation during rotation.

After an initial training phase during which it learns the code produced by the transmitter, the receiver 15, which is tuned to the incidental frequency band of the transmitter 14 during construction, receives the waves emitted by the transmitter 14, reconstitutes the original signals, then addresses them to a computer 13 to which it is attached.

On the basis of the signals transmitted by the receiver 15, the computer 13 is able to calculate the direction of rotation and/or speed of rotation and/or position of the encoder 5 in relation to the measuring device 7, and address them to any system that requires this information.

This use of a radio wave transmitter/receiver system makes it possible to do away with restrictions concerning the relative positioning of the receiver 15 and transmitter 14 with regard to one another.

In particular, if the transmitter has a transmission power of 5 milli-watts, for example, and the antenna 20 is 3 centimeters long, the receiver 15 can be placed as far as 2 meters away from the transmitter 14.

Thus, the transmitter 14 is incorporated into the unit 4 during manufacture and the receiver 15, which is external to this transmitter, may be placed in any part of the vehicle without restriction.

In addition, the same unit 4 according to the invention can be used either in a bearing 1 with either a stationary or a rotating inner ring.

Indeed, because the measuring device 7 has no electric cables connecting the unit 4 to an external stationary part, it can be rotated with the rotating ring.

In this regard, taking the example of the unit 4 shown in FIGS. 1 and 2, either armature 6 is attached to the stationary ring and armature 8 is attached to the rotating ring, or armature 6 is attached to the rotating ring and armature 8 is attached to the stationary ring.

Alternatively, the inner ring of bearing 1 shown in FIGS. 1 and 2 can be either stationary or rotating.

In addition, and to improve the rotational capacity of the measuring device 7 while at the same time improving its dynamic balancing, the measuring device 7 may be attached to the sensor-support armature 8, 6 by means of a sealing lip 21 to eliminate the negative effects of imbalance during rotation.

For example, the sealing lip 21 is attached to the sensor-support armature 8, 6 by means of“plunged bosses”, fitting against its circumference partially or completely, depending on the diameter of the bearing 1 in relation to the dimensions of the circuit 16.

According to the invention, the unit 4 can be assembled to its mounting between the pre-installed stationary ring 2 and rotating ring 3 of the bearing, thus eliminating the need for precise positioning of the encoder 5 in relation to the sensing elements 12.

In addition, in the unit 4, the distance between the encoder 5 and the sensing elements 12 is short, set during construction, and never varies over time.

The incorporation of the unit 4 into a bearing 1 is thereby facilitated and has no impact on the size of the bearing 1, in particular due to its low axial dimensions.

1. A bearing or bearing assembly of the type that contains at least one stationary ring designed to be attached to a stationary structure, at least one rotating ring designed to be attached to a rotating structure, rolling elements between said rings and, installed between a stationary ring and a rotating ring, a unit that includes:
an encoder-support armature to which the encoder is attached;
a device for measuring the pulses emitted by the encoder that is able to generate digital signals as a function of the magnetic field being measured; and
a sensor-support armature to which the measuring device is attached at air gap distance from the encoder;
said bearing being characterized by the fact that the unit also includes a radio transmitter connected to said measuring device in such a way as to transmit a radio wave representing the signals generated by said device to an external receiver designed to be located away from the unit, said receiver being capable, on the basis of these waves, of addressing to a computer the signals necessary for calculating the direction of rotation and/or speed of rotation and/or position of the encoder in relation to the measuring device.

2. A bearing according to claim 1, characterized by the fact that the encoder-support armature is attached to the stationary ring and the sensor-support armature is attached to the rotating ring.

3. A bearing according to claim 1, characterized by the fact that the encoder-support armature is attached to the rotating ring and the sensor-support armature is attached to the stationary ring.

4. A bearing according to claim 1, characterized by the fact that the radio transmitter is built in to the measuring device in an ASIC circuit (application-specific integrated circuit).

5. A bearing according to claim 1, characterized by the fact that the measuring device includes at least one sensing element located opposite and at air gap distance from the encoder, said sensing elements being selected from among the Hall effect sensors, magneto resistors, and giant magneto resistive speed sensors.

6. A bearing according to claim 5, characterized by the fact that the measuring device includes a plurality of aligned sensing elements.

7. A bearing according to claim 1, characterized by the fact that the encoder is a ring-shaped part made of synthetic material embedded with ferrite particles constituting a series of contiguous domains, each of whose direction of magnetization is opposite to that of the two domains that are contiguous with it, said part being molded onto the encoder-support armature.

8. A bearing according to claim 1, characterized by the fact that the radio transmitter receives its electrical power supply from a battery and by the fact that the transmitter is placed in standby mode when it is not sensing any relative movement between the encoder and the measuring device.

9. A bearing according to claim 1, characterized by the fact that the radio transmitter receives its electrical power supply from a coil coupled to the alternating magnetic field generated by the encoder.

10. A bearing according to claim 4, characterized by the fact that the antenna of the radio transmitter consists of a circular track fashioned into the circuit.

11. A bearing according to claim 10, characterized by the fact that:
the armature includes a radial disk and, immovably attached, an axial cylindrical roller bearing designed to be fitted onto one of the supports;
the armature includes a radial disk on the end of which is an axial cylindrical roller bearing designed to be fitted onto the other support.

12. A bearing according to claim 11, characterized by the fact that:
the armature also includes an axially shifted annular groove formed between the disk and the roller bearing;
an elastomer shield having an axial lip and a radial lip is molded onto the radial disk of the armature;
lip is positioned in the groove resting against the free inner face of the disks, and lip is resting directly against in a groove in the inner ring.

13. A bearing according to claim 11, characterized by the fact that the encoder is attached to the outer face of the disk, and by the fact that the measuring device is connected to the outer face of the disk with the sensing elements located opposite and at air gap distance from the encoder.

14. A bearing according to claim 11, characterized by the fact that the encoder is connected to the inner face of the disk, and the measuring device is connected to the inner face of the disk with the sensing elements located opposite and at air gap distance from the encoder.

15. A bearing according to claim 13, characterized by the fact that the measuring device is attached to the sensor-support armature by means of a sealing lip.

16. A bearing according to claims 11, characterized by the fact that the outer faces of the rings and the disk are contained more or less within a plane P in such a way as to limit the axial dimensions of the bearing.

17. A process for installing a bearing according to claims 1, characterized by the fact that it includes the following steps:
pre-assembly of the unit;
installation of the pre-assembled unit between a stationary ring and a rotating ring of the previously installed bearing.
